(19) United States
(12) Patent Application Publication
(10) Pub. No.: US 2012/0004954 A1
(43) Pub. Date: Jan. 5, 2012

(54) Crowd-Sourced Shopping List Augmentation

(75) Inventors: Jacob D. Eisinger, Austin, TX (US); Michael C. Hollinger, Round Rock, TX (US); Jennifer E. King, Austin, TX (US); Christina K. Lauridsen, Austin, TX (US); Fabian F. Morgan, Austin, TX (US)

(73) Assignee: INTERNATIONAL BUSINESS MACHINES CORPORATION, Armonk, NY (US)

(21) Appl. No.: 12/829,589

(22) Filed: Jul. 2, 2010

(51) Int. Cl. G06Q 30/00

(52) U.S. Cl. 705/14.1

(57) ABSTRACT

A method for receiving shopping recommendations is provided. In response to adding, by a client device, an item to a current shopping list of a customer, the client device sends the current shopping list with the added item to a server device for a shopping recommendation. In response to receiving, from the server device, a recommendation for a new item not found in the current shopping list of the customer, the client device displays the recommendation for the new item in the current shopping list of the customer. It is also determined whether a purchase incentive is associated with the new item recommended by the server device. In response to determining that a purchase incentive is associated with the new item recommended by the server device, the client device displays the purchase incentive with the new item recommended by the server in the current shopping list of the customer.

### BACKGROUND

1. Field:

The disclosure relates generally to an improved data processing system, and more specifically, to a computer implemented method, system, and computer usable program code for augmenting a shopping list while a customer shops in a store for items contained in the list.

2. Description of the Related Art

Today, mobile devices and smart phones are quickly becoming the newest, most popular platform for innovation, software services, viral marketing, and ad distribution. Typically, consumers make purchases of household goods based on items found in a shopping list. While this shopping list may be exhaustive, sometimes items are forgotten, inconveniencing the consumer and lowering sales revenue for the retailer. Retailers usually attempt to “up-sell” items that are related by placing these complimentary items physically near one another. For example, a retailer may place salsas and dips next to bags of chips on store shelves or in store displays.

However, sometimes these simple relationships between products are not easily spotted or applicable to all consumers. For example, a single person who buys a bag of chips may be more inclined to purchase a DVD to watch while eating the chips, whereas a parent with two kids purchasing the same bag of chips may be more inclined to purchase lunch meats to include in the kids' school lunches along with the chips. If some way existed to differentiate between these different types of shoppers based on their shopping habits while they were still shopping in the store, then retailers may be able to up-sell more relevant items, providing the consumer with a highly-targeted buying experience, and providing the retailer with increased sales.

### SUMMARY

According to one embodiment of the present invention, a method for receiving shopping recommendations is provided. In response to adding by a client device an item to a current shopping list of a customer, the client device sends the current shopping list with the added item to a server device for a shopping recommendation. In response to receiving from the server device a recommendation for a new item not found in the current shopping list of the customer, the client device displays the recommendation for the new item in the current shopping list of the customer. It is also determined whether a purchase incentive is associated with the new item recommended by the server device. In response to determining that a purchase incentive is associated with the new item recommended by the server device, the client device displays the purchase incentive with the new item recommended by the server in the current shopping list of the customer.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is one example of a user interface in accordance with an illustrative embodiment;

FIG. 4 is another example of a user interface in accordance with an illustrative embodiment;

FIG. 5 is a diagram of data mapping by a server device in accordance with an illustrative embodiment;

FIG. 6 is a flowchart illustrating a process for a client device connected to a shopping helper service server in accordance with an illustrative embodiment;

FIG. 7 is a flowchart illustrating a process for a server device connected to a customer client in accordance with an illustrative embodiment; and

FIG. 8 is a flowchart illustrating a process for a server device connected to a merchant client in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by, or in connection with, an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

Illustrative embodiments provide a computer implemented method, system, and computer usable program code for augmenting or supplementing customers' shopping lists while the customers are still shopping in the stores for items contained in their respective shopping lists. Consumers are increasingly turning to electronic task and list management methodologies, such as “Today's To Do List” or “Things to Remember.” However, these task-oriented or list-oriented management methodologies focus solely on a single user. In a crowd of customers with similar interests, it may be possible to extract information from this crowd of customers having electronic shopping lists to search for patterns and groups of similar lists within the crowd. Illustrative embodiments aggregate each customer's electronic shopping list with other electronic shopping lists in the crowd to determine patterns and relationships between items in the aggregated shopping lists. Then, illustrative embodiments are pushed back or sent to each individual customer's shopping list recommendations for possible additional purchases not currently included in the shopping list.

For example, a customer that typically includes in a shopping list a box of cake mix, icing, oil, and eggs is probably going to make a cake. If several other customers also list the same groups of items in their respective shopping lists, then illustrative embodiments generate a relationship between these items. Should any one customer forget to list one or more of these items in the group of related items, then illustrative embodiments utilize a recommendation engine in a server to augment the shoppers' lists with recommendations or suggestions to include the missing items.

Illustrative embodiments allow a customer client to send an electronic shopping list to a server over a network and then have the electronic shopping list returned with one or more recommendations or suggestions for additional items that other shoppers have on their shopping lists, but is not included in the client's electronic shopping list. In addition, illustrative embodiments provide a client user interface, which allows users to accept or reject the additional items recommended by the server. Further, illustrative embodiments may deliver incentives to clients to further encourage sharing of their shopping list data.

Illustrative embodiments provide these recommendations to the client customer prior to purchasing of items that are included in the electronic shopping list. The client software application of illustrative embodiments may run on the customer's mobile device, such as a cellular telephone. Alternatively, the client software may, for example, run on an electronic device built-in to a shopping cart or on a home personal computer. As a client customer enters an item in the customer's shopping list, software on the server compares the shopping list to other anonymously shared shopping lists from a plurality of other customers. Utilizing relationship-mapping software, the server recommends to the client any items that may be likely additional purchases. These additional purchases may, for example, be presented or displayed at the bottom of the user's electronic shopping list. Alternatively, the server may send a notification via, for example, electronic mail or instant messaging, which states, “You forgot the milk! Other customers who purchased cake mix, eggs, oil, and icing also purchased milk.”

As items are added to the electronic shopping list by the customer, the shopping list is continuously updated or refreshed on the remote server in real-time. The shopping lists of a multitude of users are stored and aggregated and then are used to provide recommendations for additional purchases of items not found in a shopping list of a client customer. Illustrative embodiments utilize an incentive scheme to encourage sharing of shopping list data by the customers. Customers who publish their shopping lists may receive discounts on purchases based on their participation in this shopping helper service. These discounts may be made either on items that are already in their list or on items added to the customer's shopping list as recommendations for additional purchase.

Depending on the specific illustrative embodiment, shopping list creation may be performed in real-time manually or automatically. If the client software runs on a specially-augmented “smart shopping cart,” bar code scanners or radio frequency identification tag readers may track items added to or removed from the smart shopping cart to automatically build the customer's shopping list. In this particular illustrative embodiment, recommended items may appear in a separate portion of the user interface or within a pop-up window in the user interface.

If the client software is run on a mobile communication device, the customer manually enters and maintains the shopping list. As items in the shopping list are picked up, the customer “checks” off the items that are no longer needed. Using illustrative embodiments, the customer may, for example, download the shopping list from a web service maintained by a store, some third party service, or from the user's home computer.

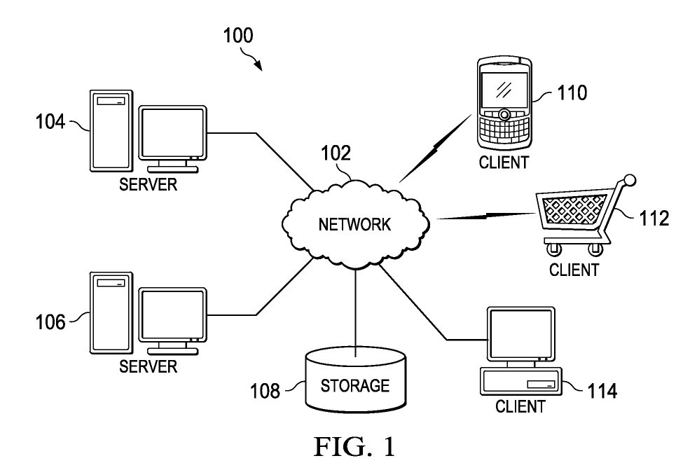

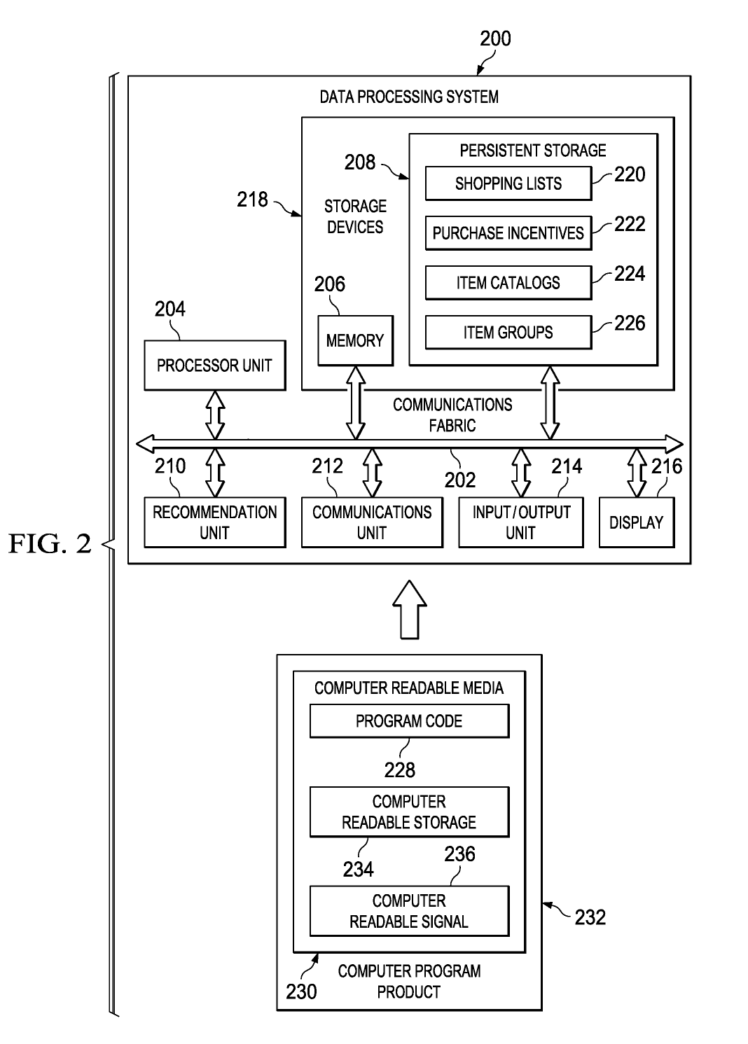

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers and other devices in which the illustrative embodiments may be implemented. Network data processing system 100 contains network 102, which is the medium used to provide communications links between the computers and other various devices connected together within network data processing system 100. Network 102 may include connections, such as wire, wireless communication links, or fiber optic cables.

In the depicted example, server 104 and server 106 connect to network 102, along with storage unit 108. Server 104 may, for example, be a server device utilized by a shopping helper service. A shopping helper service is a system of components used for augmenting or supplementing a customer's shopping list with recommended new items not currently on the list based on shared shopping lists of other customers. In addition, the shopping helper service may augment the shopping list with incentives, which are provided by merchants, to purchase the recommended new items.

Server 106 may, for example, be a server device utilized by a merchant. A merchant may, for example, be a seller, manufacturer, or producer of items. An item may be a product or a service. In this example, server 106 is a client to server 104, which provides the shopping helper service. Server 106 provides a catalog or list of items for sale by the merchant to server 104. Further, server 106 provides to server 104 any incentives offered by the merchant to purchase items in the catalog. Also, it should be noted that server 106 may represent a plurality of merchant servers representing a plurality of different merchants.

Storage 108 is a network storage device capable of storing data in a structured or unstructured format. In addition, even though storage 108 is depicted as a stand-alone device, storage 108 may be included in server 104. Further, storage unit 108 may represent a plurality of storage units connected to network 102.

Storage 108 may, for example, store data, such as anonymously shared shopping lists for a plurality of customers, purchase incentives provided by merchants, catalogs of items for sale by merchants, and lists of item groups. An item group is a set of two or more items that are related. Item groups are determined, for example, by relationship mapping of items from the shared shopping lists of the plurality of customers. In addition, storage 108 may store identification data for individual customers, merchants, shopping lists, items, purchase incentives, and item groups. Further, storage 108 may store login information for customers and merchants. The login information may, for example, include a unique user name and password.

Clients 110, 112, and 114 also connect to network 102. In this depicted example, client 110 is a cellular telephone, a personal digital assistant, or any other type of handheld electronic device capable of sending and receiving data over network 102. Client 112 is a smart shopping cart capable of scanning bar codes or reading radio frequency identification tags associated with items for sale by a merchant and displaying this type of information to the customer. In addition, the smart shopping cart also is capable of sending and receiving data over network 102. Client 114 is a personal computer or network computer. Also in this depicted example, a customer may, for example, generate a shopping list on client 114 at home and then send the shopping list to server 104. Afterward, the customer may later wirelessly download the shopping list from server 104 to client 110 or client 112 while shopping at a merchant's store.

In the depicted example, server 104 provides information, such as boot files, operating system images, and applications to clients 110, 112, and 114. Clients 110, 112, and 114 are clients to server 104. Further, network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a diagram of a data processing system is depicted in accordance with an illustrative embodiment. Data processing system 200 is an example of a computer, such as server 104 or client 114 in FIG. 1, in which computer usable program code or instructions implementing processes of illustrative embodiments may be located. In this illustrative example, data processing system 200 includes communications fabric 202, which provides communications between processor unit 204, memory 206, persistent storage 208, recommendation unit 210, communications unit 212, input/output (I/O) unit 214, and display 216.

Processor unit 204 serves to execute instructions for software applications or programs that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 218. A storage device is any piece of hardware that is capable of storing information, such as, for example, without limitation, data, program code in functional form, and/or other suitable information either on a transient basis and/or a persistent basis. Memory 206, in these examples, may, for example, be a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Persistent storage 208 stores shopping lists 220, purchase incentives 222, item catalogs 224, and item groups 226. In addition, persistent storage 208 may store other types of information, such as shopping habits of a social network of customers. Shopping habits of the social network of customers may, for example, include how often the customers shop, what days of the week the customers shop, what time of day the customers shop, where the customers shop, and how much money the customers spend while shopping. A social network is a community of customers that share common interests, such as sharing shopping lists, with one another and are coupled together by a network, such as network 102 in FIG. 1. The social network may, for example, include all customers connected to the network or only include a predefined subset of customers connected to the network, such as members of a particular shopping helper service.

Shopping lists 220 represent a plurality of shopping lists obtained from a plurality of shoppers that are registered for the shopping helper service. A shopping list contains one or more items that a shopper desires to purchase from one or more merchants. An item is a product or service provided by a merchant for a fee or price. A merchant is a seller of one or more items included in the shopping list.

Purchase incentives 222 represent something that encourages or motivates customers to purchase additional items from merchants. For example, an incentive may be offering a shopper a discounted price, such as ten percent off, for purchasing an item recommended by the service that is not currently on a shopper's shopping list. Or, an incentive may be offering a higher discounted price, such as twenty percent off, for purchasing a particular brand of a recommended item. Purchase incentives 222 are provided by merchants registered with the shopping helper service.

Item catalogs 224 represent a plurality of catalogs listing items available for sale by registered merchants. Item catalogs 224 may also include descriptions and/or prices of the listed items. Item groups 226 represent a plurality of items that are aggregated into a plurality of different groups or sets of items that are related in some way. An item group is a grouping of a plurality of different items based on relationship mapping of those items, which come from the shared shopping lists of the plurality of customers. Relationship mapping is a mapping that describes how relationships or associations exist between two or more items or objects. Mapping refers to how items and the relationships between those items are mapped to tables and the relationships between the tables.

It should be noted that an item may be included in a plurality of item groups. Also, groups of items may not be merchant specific or store specific. Further, data processing system 200 may perform relationship mapping of groups of items in real-time up to a predefined time threshold or a maximum allowed compute time for processor unit 204. The mapping returns, for example, identification numbers for each of the item groups and identification numbers for each of the items in each of the different item groups.

Recommendation unit 210 is the component responsible for making recommendations of new items to client customers. The recommendations are based on the grouping of items contained in the customer's shopping list with items in item groups 226. Recommendation unit 210 is a combination of hardware and software components. However, recommendation unit 210 may be entirely comprised of software components.

The recommended new items are items that are not currently on the client customer's electronic shopping list. For example, recommendation unit 210 may recommend spaghetti to a client customer when the customer's electronic shopping list does not include spaghetti, but does include spaghetti sauce. Recommendation unit 210 recommends spaghetti in this situation because other shared customers' electronic shopping lists include spaghetti when spaghetti sauce is also listed.

Further, recommendation unit 210 may include a purchase incentive with the recommendation of the new item to encourage the client customer to purchase the recommended new item. Thus, recommendation unit 210 may save the client customer the headache of returning to the store to purchase a forgotten essential ingredient in tonight's dinner. Also, recommendation unit 210 may increase sales for client merchants, which are providing the incentives to purchase the additional items recommended by recommendation unit 210.

Communications unit 212, in these examples, provides for communication with other data processing systems or devices. In these examples, communications unit 212 is a network interface card. Communications unit 212 may provide communications through the use of either or both physical and wireless communications links.

Input/output unit 214 allows for the input and output of data with other devices that may be connected to data processing system 200. For example, input/output unit 214 may provide a connection for user input through a keyboard, a mouse, and/or some other suitable input device. Further, input/output unit 214 may send output to a printer. Display 216 provides a mechanism to display information to a user.

Instructions for the operating system, applications, and/or programs may be located in storage devices 218, which are in communication with processor unit 204 through communications fabric 202. In these illustrative examples, the instructions are in a functional form on persistent storage 208. These instructions may be loaded into memory 206 for running by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code, in the different embodiments, may be embodied on different physical or computer readable storage media, such as memory 206 or persistent storage 208.

Program code 228 is located in a functional form on computer readable media 230 that is selectively removable and may be loaded onto or transferred to data processing system 200 for running by processor unit 204. Program code 228 and computer readable media 230 form computer program product 232. In one example, computer readable media 230 may be computer readable storage media 234 or computer readable signal media 236. Computer readable storage media 234 may include, for example, an optical or magnetic disc that is inserted or placed into a drive or other device that is part of persistent storage 208 for transfer onto a storage device, such as a hard drive, that is part of persistent storage 208. Computer readable storage media 234 also may take the form of a persistent storage, such as a hard drive, a thumb drive, or a flash memory that is connected to data processing system 200. In some instances, computer readable storage media 234 may not be removable from data processing system 200.

Alternatively, program code 228 may be transferred to data processing system 200 using computer readable signal media 236. Computer readable signal media 236 may be, for example, a propagated data signal containing program code 228. For example, computer readable signal media 236 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 228 may be downloaded over a network to persistent storage 208 from another device or data processing system through computer readable signal media 236 for use within data processing system 200. For instance, program code stored in a computer readable storage media in a server data processing system may be downloaded over a network from the server to data processing system 200. The data processing system providing program code 228 may be a server computer, a client computer, or some other device capable of storing and transmitting program code 228.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 230 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

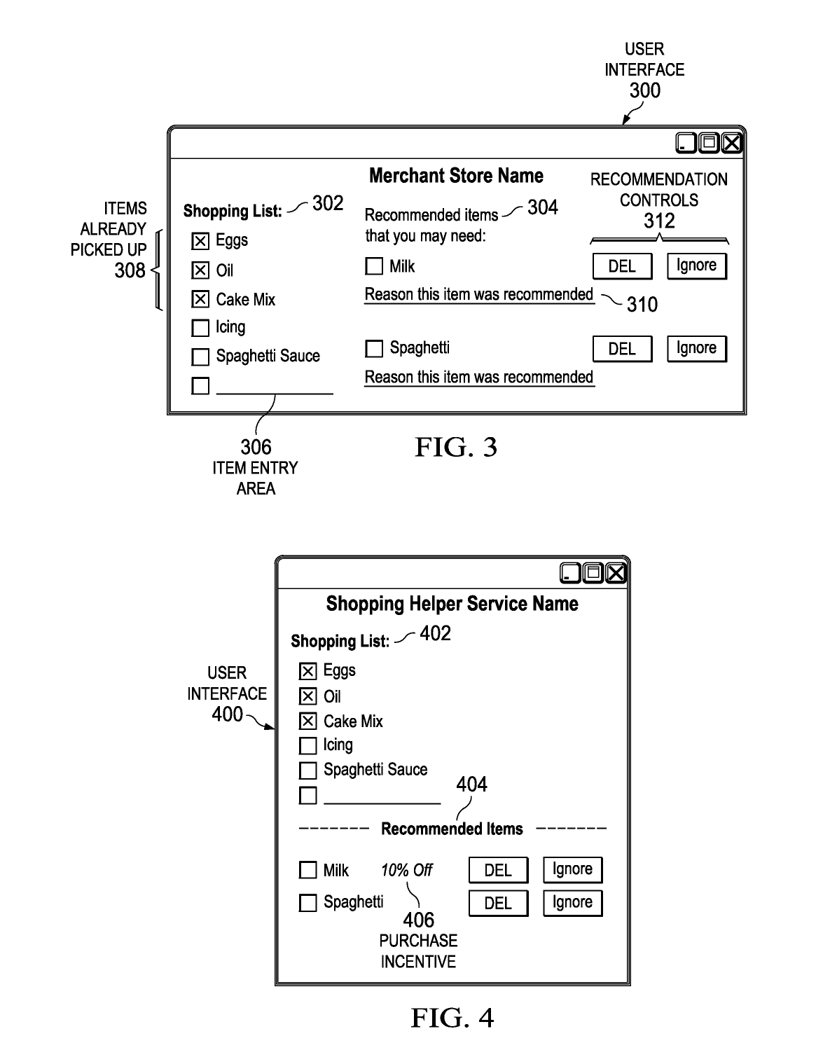

With reference now to FIG. 3, one example of a user interface is depicted in accordance with an illustrative embodiment. User interface 300 may be implemented in a client device, such as client 112 in FIG. 1, which in this example is a smart shopping cart. User interface 300 is a graphical user interface used by a customer to interact with the shopping helper service server. The shopping helper service server may, for example, be implemented in server 104 in FIG. 1 or data processing system 200 in FIG. 2.

User interface 300 includes shopping list 302 and recommended items 304. Shopping list 302 is the electronic shopping list of the customer and includes items that the customer wants to buy at the store. In this example, the store is a grocery store as indicated by the type of items listed in shopping list 302. Shopping list 302 may, for example be downloaded from a server, such as server 104 in FIG. 1. In other words, the electronic shopping list was previously created on, for example, a home computer, such as client 114 in FIG. 1, and then sent to the server for later download.

In addition, the customer may, for example, manually enter all or only a portion of shopping list 302 in user interface 300 by utilizing item entry area 306. Further, a smart shopping cart client device may automatically add items to shopping list 302 after, for example, scanning or reading a product label of an item placed in the cart by the customer. Furthermore, the smart shopping cart client device may automatically check items as already picked up, as indicated by items already picked up 308, after scanning an item included in shopping list 302.

Recommended items 304 are items that are not currently included in shopping list 302, but are recommended by a recommendation unit, such as recommendation unit 210 in FIG. 2, in the shopping helper service server. Recommended items 304 are items that the customer may need based on an analysis of a plurality of other customers'anonymously shared shopping lists, such as shopping lists 220 in FIG. 2. In this example, a recommended new item not included in shopping list 302 is milk.

User interface 300 also includes reason this item was recommended 310. Reason this item was recommended 310 provides the customer with an explanation as to why the recommendation was made or the basis for the recommendation. In this example, the reason milk was recommended is because other customers' shopping lists that included eggs, oil, cake mix, and icing, also included milk.

User interface 300 also includes recommendation controls 312. The customer uses recommendation controls 312 to, for example, delete the recommendation or ignore the recommendation. In addition, user interface 300 may also include other information, such as the merchant store name, store advertising, item coupons, and other relevant information for the customer.

With reference now to FIG. 4, another example of a user interface is depicted in accordance with an illustrative embodiment. User interface 400 may be implemented in a client device, such as client 110 in FIG. 1, which in this example is a cellular telephone or other handheld communication device. User interface 400 is a graphical user interface used by a customer to interact with the shopping helper service server. The shopping helper service server may, for example, be implemented in server 104 in FIG. 1 or data processing system 200 in FIG. 2.

User interface 400 includes shopping list 402 and recommended items 404, such as shopping list 302 and recommended items 304 in FIG. 3. User interface 400 also includes purchase incentive 406. Purchase incentive 406 is provided by a merchant to induce a customer to purchase one or more items listed in recommended items 404. In addition, purchase incentive 406 may be provided by a manufacturer of items to encourage customers to purchase the manufacturer's particular brand of products recommended in recommended items 404. As a result, both customers and merchants benefit through redemption of these incentives. Furthermore, customers may potentially benefit by purchasing a new product that the customers may not have otherwise tried without receiving purchase incentive 406.

In this example, purchase incentive 406 is a ten percent (10%) off discount on the purchase of milk, which was not originally included in shopping list 402 by the customer. In addition, user interface 400 may also include other information, such as the name of the shopping helper service, the website address of the service, links to other associated services, and any other information that the customer may find useful while shopping.

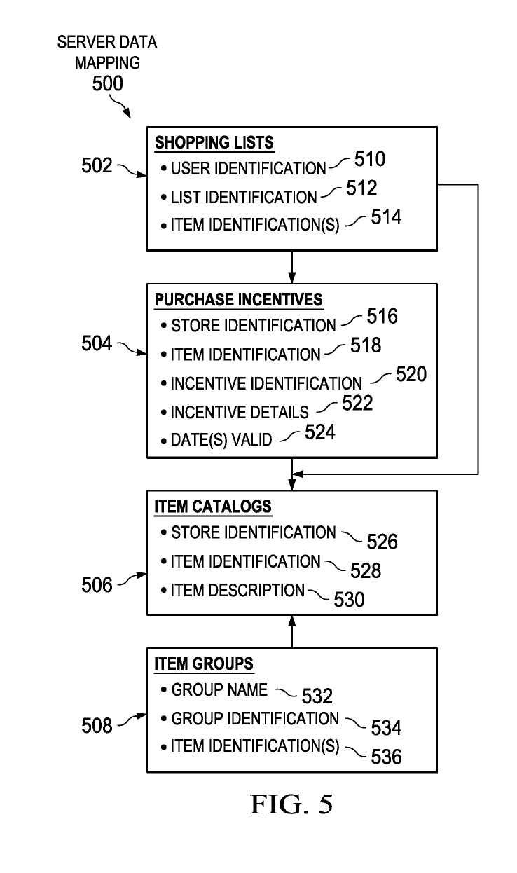

With reference now to FIG. 5, a diagram of data mapping by a server device is depicted in accordance with an illustrative embodiment. Server data mapping 500 represents mapping of data by a server device, such as server 104 in FIG. 1, which provides the shopping helper service of illustrative embodiments. Server data mapping 500 includes shopping lists 502, purchase incentives 504, item catalogs 506, and item groups 508, such as shopping lists 220, purchase incentives 222, item catalogs 224, and item groups 226 in FIG. 2.

Shopping lists 502 include user identification (ID) 510, list identification 512, and item identification 514. User identification 510 associates a user or customer to one or more shopping lists created by a particular user. List identification 512 identifies a particular shopping list in shopping lists 502. Item identification 514 particularly identifies items in a shopping list.

Purchase incentives 504 include store identification 516, item identification 518, incentive identification 520, incentive details 522, and date(s) valid 524. Store identification 516 identifies a particular store or merchant that is providing a particular purchase incentive. Item identification 518 identifies which item is associated with the incentive. Incentive identification 520 identifies the particular purchase incentive. Incentive details 522 provide a description of a particular incentive offered by a store. Date(s) valid 524 identify the dates that a particular purchase incentive is applicable.

Item catalogs 506 include store identification 526, item identification 528, and item description 530. Store identification 526 identifies the store or merchant that is associated with items in one or more item catalogs. Item identification 528 identifies particular items in the catalogs. Item description 530 provides details for items listed in the catalogs.

Item groups 508 include group name 532, group identification 534, and item identification 536. Group name 532 provides a name for each grouping or set of items. Group identification 534 identifies each particular group of items. Item identification 536 identifies each item within the different groups of items.

In this illustrative example, the server maps the data contained in shopping lists 502, purchase incentives 504, and item groups 508 to items in item catalogs 506 in order to make recommendations to client devices. For example, the server maps the items contained in a shopping list received from a customer to items contained in a merchant's catalog of items available for sale. In addition, the server maps those items in the customer's shopping list to purchase incentives provided by merchants for possible matches. Further, the server maps the items in the customer's shopping list to the group of items to determine items that may be missing from the customer's shopping list based, for example, on relationship mapping of data. Afterward, the server sends the customer any recommendations discovered in the mapping process, along with any incentives found to be associated with the recommended items.

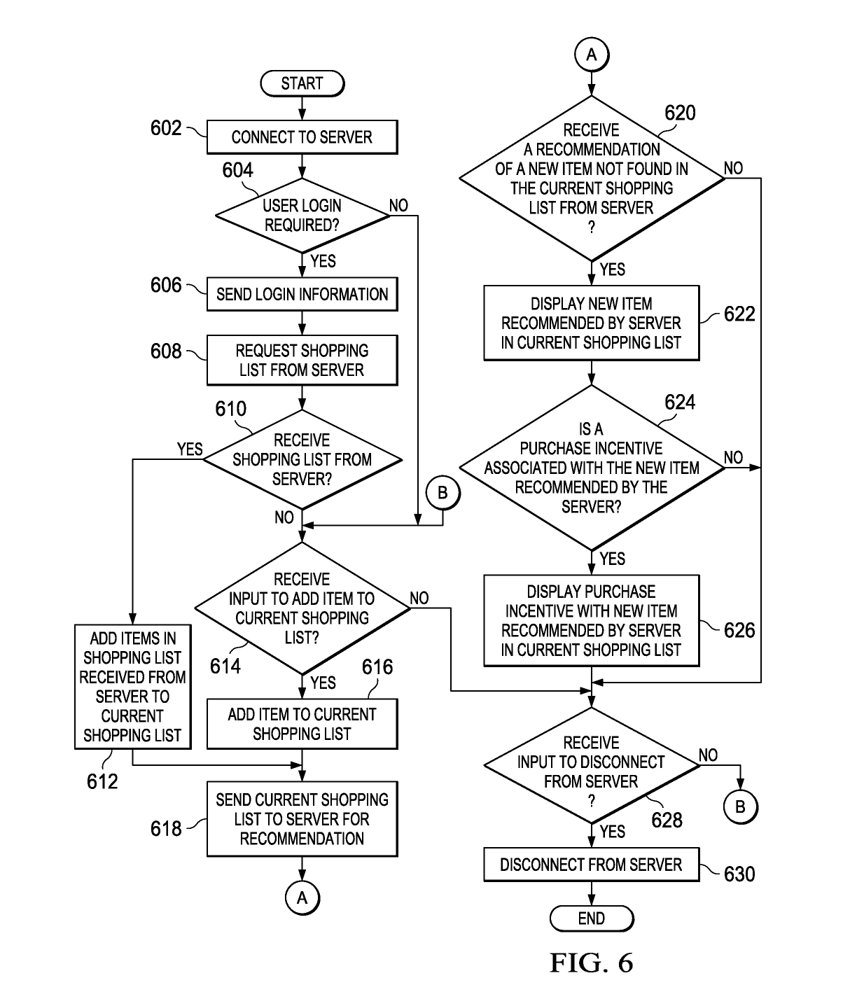

With reference now to FIG. 6, a flowchart illustrating a process for a client device connected to a shopping helper service server is shown in accordance with an illustrative embodiment. The process shown in FIG. 6 may be implemented in a client device, such as client device 110 in FIG. 1.

The process begins when the client device connects to the shopping helper service server, such as server 104 in FIG. 1 (step 602). After connecting to the server in step 602, the client device makes a determination as to whether a user login is required for the shopping helper service (step 604). If the client device determines that a user login is required, yes output of step 604, then the client device sends the login information to the server (step 606).

Afterward, the client device requests a shopping list from the server (step 608). Subsequently, the client device makes a determination as to whether the client device received a shopping list from the server (step 610). If the client device determines that the client device did not receive a shopping list from the server, no output of step 610, then the process proceeds to step 614. If the client device determines that the client device did receive a shopping list from the server, yes output of step 610, then the client device adds items in shopping list received from the server to a current shopping list (step 612). Thereafter, the process proceeds to step 618.

Returning now to step 604, if the client device determines that a user login is not required, no output of step 604, then the client device makes a determination as to whether the client device received an input to add an item to a current shopping list (step 614). If the client device determines that the client device did not receive an input to add an item to the current shopping list, no output of step 614, then the process proceeds to step 628. If the client device determines that the client device did receive an input to add an item to the current shopping list, yes output of step 614, then the client device adds the item to the current shopping list (step 616).

Afterward, the client device sends the current shopping list to the server for a recommendation (step 618). Subsequent to sending the current shopping list to the server in step 618, the client device makes a determination as to whether the client device received a recommendation of a new item not found in the current shopping list from server (step 620). If the client device determines that the client device did not receive a recommendation of a new item not found in the current shopping list from server, no output of step 620, then the process proceeds to step 628. If the client device determines that the client device did receive a recommendation of a new item not found in the current shopping list from server, yes output of step 620, then the client device displays the new item recommended by the server in the current shopping list (step 622).

In addition, the client device makes a determination as to whether a purchase incentive is associated with the new item recommended by the server (step 624). If the client device determines that a purchase incentive is not associated with the new item recommended by the server, no output of step 624, then the process proceeds to step 628. If the client device determines that a purchase incentive is associated with the new item recommended by the server, yes output of step 624, then the client device displays the purchase incentive with the new item recommended by the server in the current shopping list, such as purchase incentive 406 in FIG. 4 (step 626).

Subsequently, the client device makes a determination as to whether the client device receives an input to disconnect from the server (step 628). If the client device determines that the client device did not receive an input to disconnect from the server, no output of step 628, then the process returns to step 614 where the client device waits to receive an input to add an item to the current shopping list. If the client device determines that the client device did receive an input to disconnect from the server, yes output of step 628, then the client device disconnects from the server (step 630). The process terminates thereafter.

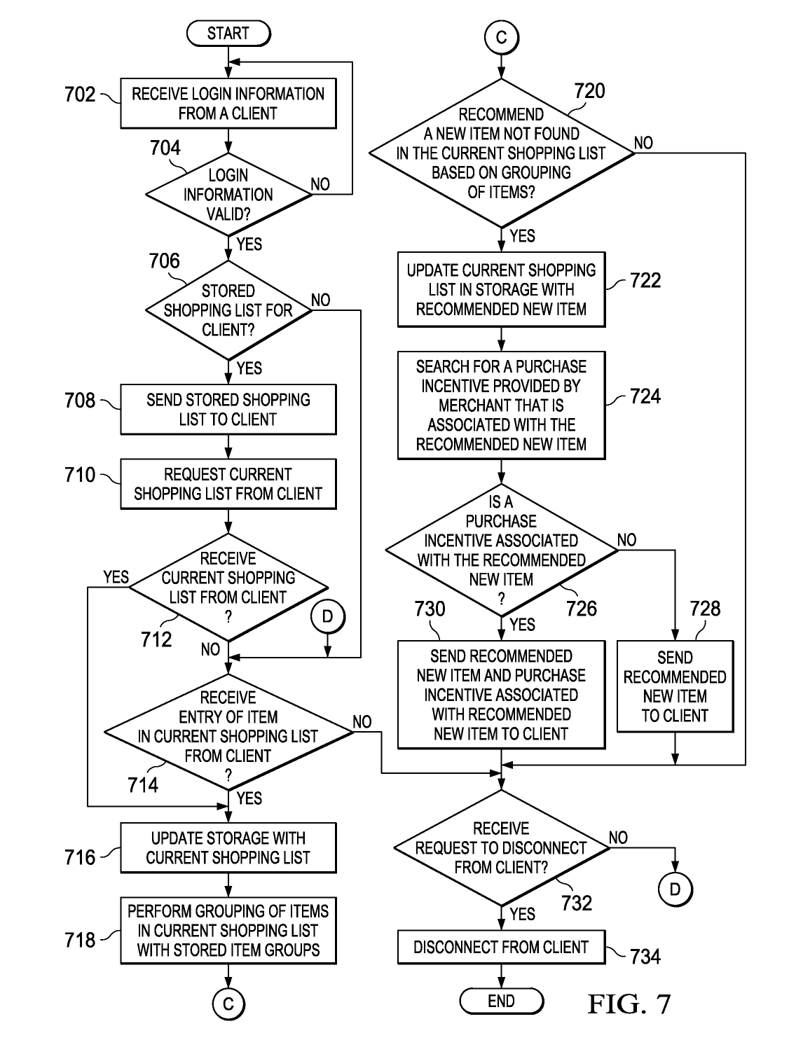

With reference now to FIG. 7, a flowchart illustrating a process for a server device connected to a customer client is shown in accordance with an illustrative embodiment. The process shown in FIG. 7 may be implemented in a server device, such as server device 104 in FIG. 1.

The process begins when the server device receives login information from a client device (step 702). After receiving the login information in step 702, the server makes a determination as to whether the login information from the client is valid (step 704). If the server determines that the login information is not valid, no output of step 704, then the process returns to step 702 where the server waits for login information from the client device. If the server determines that the login information is valid, yes output of step 704, then the server makes a determination as to whether the server is storing a shopping list for the client (step 706).

If the server determines that the server is storing a shopping list for the client, yes output of step 706, then the server sends the stored shopping list to the client (step 708). Subsequently, the server requests a current shopping list from the client (step 710). Afterward, the server makes a determination as to whether the server received the current shopping list from the client (step 712). If the server determines that the server did not receive the current shopping list from the client, no output of step 712, then the process proceeds to step 714. If the server determines that the server did receive the current shopping list from the client, yes output of step 712, then the process proceeds to step 716.

Returning now to step 706, if the server determines that the server is not storing a shopping list for the client, no output of step 706, then the server makes a determination as to whether the server received an entry of an item in the current shopping list from the client (step 714). If the server determines that the server did not receive an entry of an item in the current shopping list of the client, no output of step 714, then the process proceeds to step 732. If the server determines that the server did receive an entry of an item in the current shopping list of the client, yes output of step 714, then the server updates its storage device with the current shopping list (step 716). The updated current shopping list of the client includes any newly entered items into the list.

Subsequent to updating storage with the current shopping list in step 716, the server performs a grouping of items in the current shopping list with stored item groups, such as item groups 226 in FIG. 2 and item groups 508 in FIG. 5 (step 718). The server performs the grouping of items in the current shopping list by, for example, utilizing relationship mapping to one or more previously generated groups of items. Then, the server makes a determination as to whether the server recommends a new item not found in the current shopping list based on the grouping of items (step 720).

If the server determines that the server does not recommend a new item not found in the current shopping list based on the grouping of items, no output of step 720, then the process proceeds to step 732. If the server determines that the server does recommend a new item not found in the current shopping list based on the grouping of items, yes output of step 720, then the server updates the current shopping list in its storage device with the recommended new item (step 722). In addition, the server searches the storage device for a purchase incentive provided by merchant that is associated with the recommended new item (step 724). The purchase incentive may, for example, be purchase incentive 406 in FIG. 4, which may be found in purchase incentives 222 in FIG. 2 or purchase incentives 504 in FIG. 5.

Subsequent to searching for a purchase incentive in step 724, the server makes a determination as to whether a purchase incentive is associated with the recommended new item (step 726). If the server determines that a purchase incentive is not associated with the recommended new item, no output of step 726, then the server sends the recommended new item to the client device (step 728). Thereafter, the process proceeds to step 732. If the server determines that a purchase incentive is associated with the recommended new item, yes output of step 726, then the server sends the recommended new item and the purchase incentive associated with the recommended new item to the client device (step 730).

Afterward, the server makes a determination as to whether the server received a request to disconnect from the client device (step 732). If the server determines that the server did not receive a request to disconnect from the client device, no output of step 732, then the process returns to step 714 where the server waits to receive an entry of an additional item to the current shopping list. If the server determines that the server did receive a request to disconnect from the client device, yes output of step 732, then the server disconnects from the client device (step 734). The process terminates thereafter.

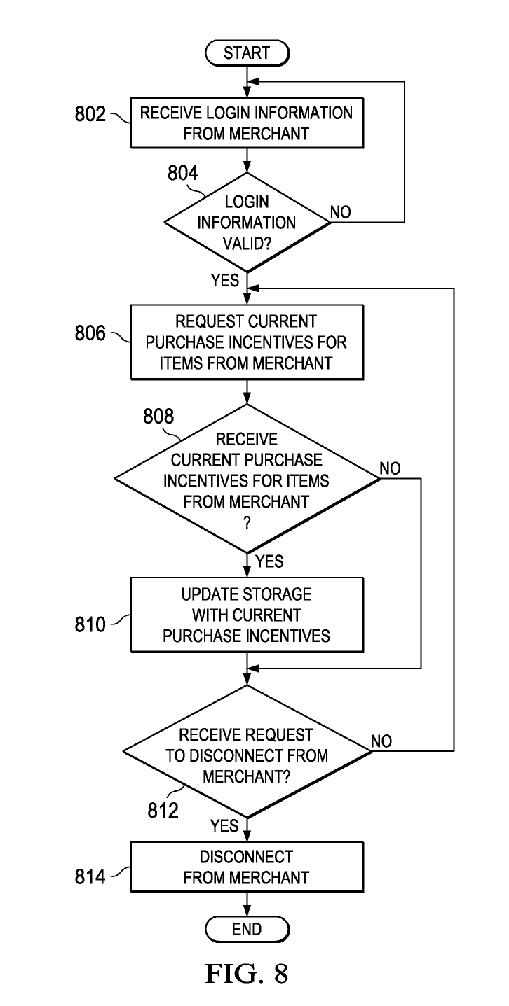

With reference now to FIG. 8, a flowchart illustrating a process for a server device connected to a merchant client is shown in accordance with an illustrative embodiment. The process shown in FIG. 8 may be implemented in a server device, such as server device 104 in FIG. 1.

The process begins when the server device receives login information from a merchant client (step 802). After receiving the login information in step 802, the server makes a determination as to whether the login information is valid (step 804). If the server determines that the login information is not valid, no output of step 804, then the process returns to step 802 where the server waits for login information.

If the server determines that the login information for the merchant is valid, yes output of step 804, then the server requests from the merchant current purchase incentives for items (step 806). Subsequently, the server makes a determination as to whether the server receives the current purchase incentives for items from the merchant (step 808). If the server determines that the server did not receive the current purchase incentives for items from the merchant, no output of step 808, then the process proceeds to step 812.

If the server determines that the server did receive the current purchase incentives for items from the merchant, yes output of step 808, then the server updates its storage device with the current purchase incentives provided by the merchant (step 810). Afterward, the server makes a determination as to whether the server receives a request to disconnect from the merchant client device (step 812). If the server determines that the server did not receive a request to disconnect from the merchant, no output of step 812, then the process returns to step 806 where the server continues to request purchase incentives from the merchant. If the server determines that the server did receive a request to disconnect from the merchant, yes output of step 812, then the server disconnects from the merchant client device (step 814). The process terminates thereafter.

Thus, illustrative embodiments of the present invention provide a computer implemented method, apparatus, and computer program product for augmenting a shopping list while a customer shops in a store for items contained in the list. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for receiving shopping recommendations, the computer implemented method comprising:
responsive to adding, by a client device, an item to a current shopping list of a customer, sending, by the client device, the current shopping list with the added item to a server device for a shopping recommendation;
responsive to receiving, from the server device, a recommendation for a new item not found in the current shopping list of the customer, displaying, by the client device, the recommendation for the new item in the current shopping list of the customer;
determining whether a purchase incentive is associated with the new item recommended by the server device; and
responsive to a determination that a purchase incentive is associated with the new item recommended by the server device, displaying, by the client device, the purchase incentive with the new item recommended by the server in the current shopping list of the customer.

2. The computer implemented method of claim 1 further comprising:
requesting, by the client device, a shopping list associated with the customer from the server device; and
responsive to receiving the shopping list requested from the server device, adding, by the client device, items in the shopping list received from the server device to the current shopping list of the customer.

3. The computer implemented method of claim 1, wherein the server device updates a storage device with the current shopping list that includes newly entered items sent by the client device in real-time.

4. The computer implemented method of claim 1, wherein the server device performs grouping of items in the current shopping list with stored item groups.

5. The computer implemented method of claim 4, wherein the server device recommends the new item not found in the current shopping list of the customer based on the grouping of the items in the current shopping list with the stored item groups.

6. The computer implemented method of claim 5, wherein the server device updates a storage device with the current shopping list that includes the new item recommended by the server.

7. The computer implemented method of claim 1, wherein a merchant provides the purchase incentive associated with the new item recommended by the server device.

8. The computer implemented method of claim 1, wherein the server device is associated with a shopping helper service.

9. The computer implemented method of claim 1, wherein the client device is a mobile communication device.

10. The computer implemented method of claim 1, wherein the server device aggregates shopping lists from a plurality of shoppers to determine patterns and relationships between items included in the aggregated shopping lists.

11. The computer implemented method of claim 1, wherein the client device includes a user interface that allows the customer to accept or reject additional items recommended by the server device.

12. The computer implemented method of claim 11, wherein the user interface includes a reason why the new item not found in the current shopping list of the customer was recommended by the server.

13. The computer implemented method of claim 4, wherein an item group is a grouping of a plurality of different items based on relationship mapping.

14. A data processing system for receiving shopping recommendations, the data processing system comprising:
a bus system;
a storage device connected to the bus system, wherein the storage device stores a set of instructions; and
a processing unit connected to the bus system, wherein the processing unit executes the set of instructions to send a current shopping list with an added item to a server device for a shopping recommendation in response to adding an item to the current shopping list of a customer; display a recommendation for a new item in the current shopping list of the customer in response to receiving from the server device the recommendation for the new item not found in the current shopping list of the customer; determine whether a purchase incentive is associated with the new item recommended by the server device; and display the purchase incentive with the new item recommended by the server in the current shopping list of the customer in response to a determination that the purchase incentive is associated with the new item recommended by the server device.

15. The data processing system of claim 14, wherein the processing unit executes a further set of instructions to request a shopping list associated with the customer from the server device; and add items in the shopping list received from the server device to the current shopping list of the customer in response to receiving the shopping list requested from the server device.

16. A computer program product including a computer readable storage medium having computer usable program code embodied thereon for receiving shopping recommendations, the computer program product comprising:
computer usable program code configured to send a current shopping list with an added item to a server device for a shopping recommendation in response to adding an item to the current shopping list of a customer;
computer usable program code configured to display a recommendation for a new item in the current shopping list of the customer in response to receiving from the server device the recommendation for the new item not found in the current shopping list of the customer;
computer usable program code configured to determine whether a purchase incentive is associated with the new item recommended by the server device; and
computer usable program code configured to display the purchase incentive with the new item recommended by the server in the current shopping list of the customer in response to a determination that the purchase incentive is associated with the new item recommended by the server device.

17. The computer program product of claim 16 further comprising:
computer usable program code configured to request a shopping list associated with the customer from the server device; and
computer usable program code configured to add items in the shopping list received from the server device to the current shopping list of the customer in response to receiving the shopping list requested from the server device.

18. The computer program product of claim 16, wherein the server device performs grouping of items in the current shopping list with stored item groups.

19. The computer program product of claim 18, wherein the server device recommends the new item not found in the current shopping list of the customer based on the grouping of the items in the current shopping list with the stored item groups.

20. The computer program product of claim 16, wherein the server device aggregates shopping lists from a plurality of shoppers to determine patterns and relationships between items included in the aggregated shopping lists.
